(19) United States
(12) Patent Application Publication
(10) Pub. No.: US 2026/0342761 A1
(43) Pub. Date: Oct. 29, 2026

(54) MANAGING GENERATIVE ARTIFICIAL INTELLIGENCE (AI) SESSION HISTORY FOR GENERATIVE AI MODELS USING INTERACTIVE ELEMENTS OF A GRAPHICAL USER INTERFACE (GUI)

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,689

(22) Filed: Apr. 28, 2025

(51) Int. Cl. H04L 51/216; G06F 3/0484

(52) U.S. Cl. CPC H04L 51/216; G06F 3/0484

(57) ABSTRACT

Methods and systems for providing computer-implemented services using generative artificial intelligence (AI) models are disclosed. To do so, input may be obtained, via at least selection by a downstream consumer of an interactive element on a graphical user interface (GUI), that a generative AI session history be reverted to an earlier point in the generative AI session history while retaining at least a portion of the generative AI session history. A temporarily updated generative AI model may be obtained so that outputs generated by the temporarily updated generative AI model are influenced less by a portion of the generative AI session history after the earlier point for a duration of the generative AI session. An output may be obtained from the temporarily updated generative AI model and based on the prompt history. Computer-implemented services may be provided to the downstream consumer using at least the output.

### FIELD

Embodiments disclosed herein relate generally to providing computer-implemented services using generative artificial intelligence (AI) models. More particularly, embodiments disclosed herein relate to managing generative AI session history for generative AI models using interactive elements of a graphical user interface (GUI).

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a flow diagram illustrating data flows in accordance with an embodiment.

FIGS. 2B-2F show an example graphical user interface (GUI) and an example generative AI session in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

The outputs may be provided to downstream consumers as part of generative AI sessions (e.g., chat sessions) with the downstream consumers. A generative AI session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The customer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

However, generative AI models may generate new outputs based on all components of the chat history (e.g., all prompts and outputs during the chat session). Therefore, if a downstream consumer mistakenly enters some information as a prompt or decides that a previously entered prompt is no longer desired to be used as part of the chat session (e.g., due to eliciting an unwanted response), the downstream consumer may have to begin a new chat session and/or may receive outputs during the chat session that do not meet needs of the downstream consumer (e.g., may be inaccurate, may be irrelevant).

To improve a user's (e.g., a downstream consumer's) experience and increase a likelihood of providing outputs that meet expectations of the downstream consumer, the user may request, via at least selection of an interactive element of the GUI, that information content be removed from a generative AI session history of the chat session. The interactive element may be an undo button. The undo button may appear: (i) upon entering a command by the downstream consumer to the GUI, (ii) upon selection of another interactive element to enter into an “undo” mode, (iii) by hovering, using a cursor controlled by a human interface device of the downstream consumer such as a mouse, over an element of the chat history, and/or (iv) via other methods.

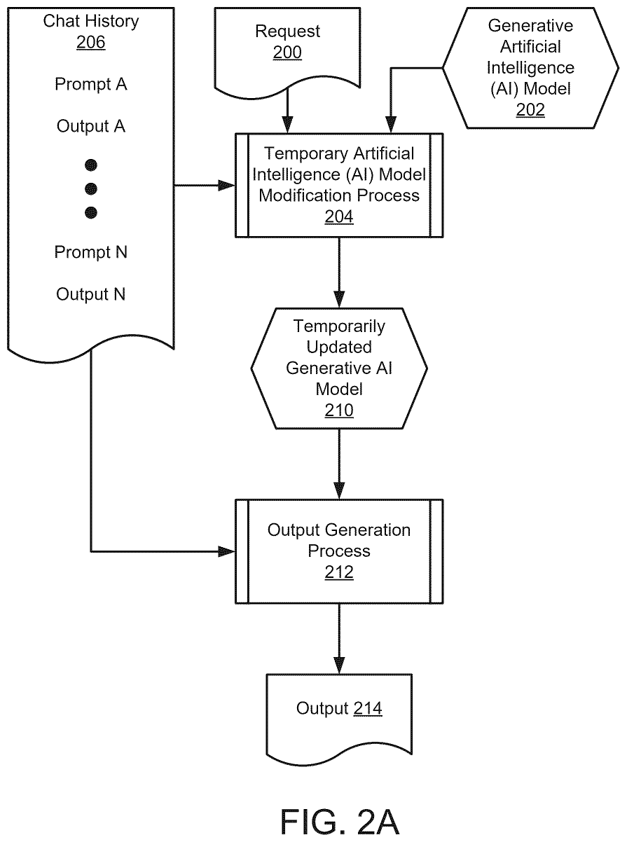

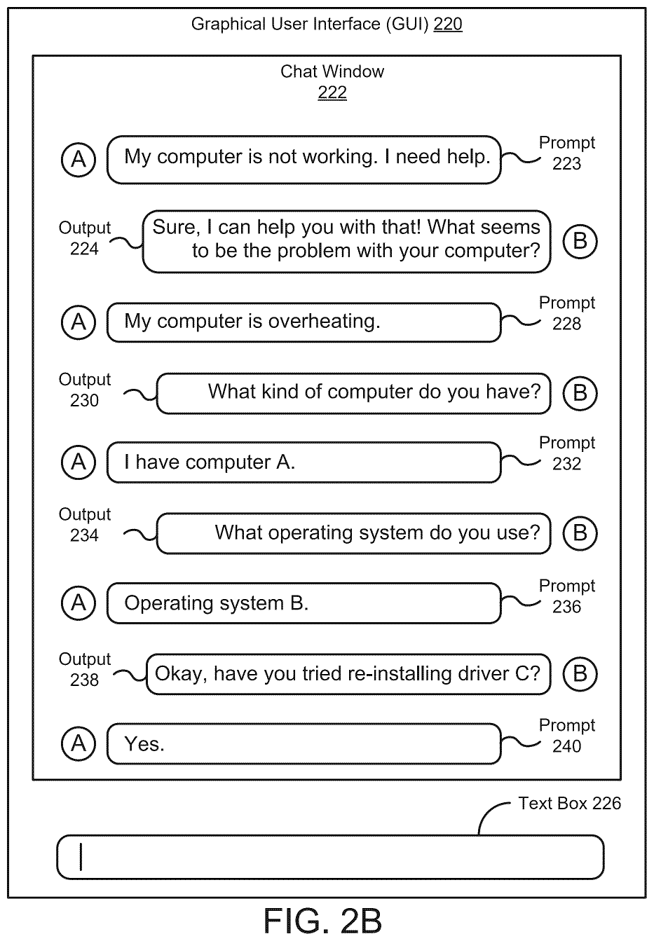

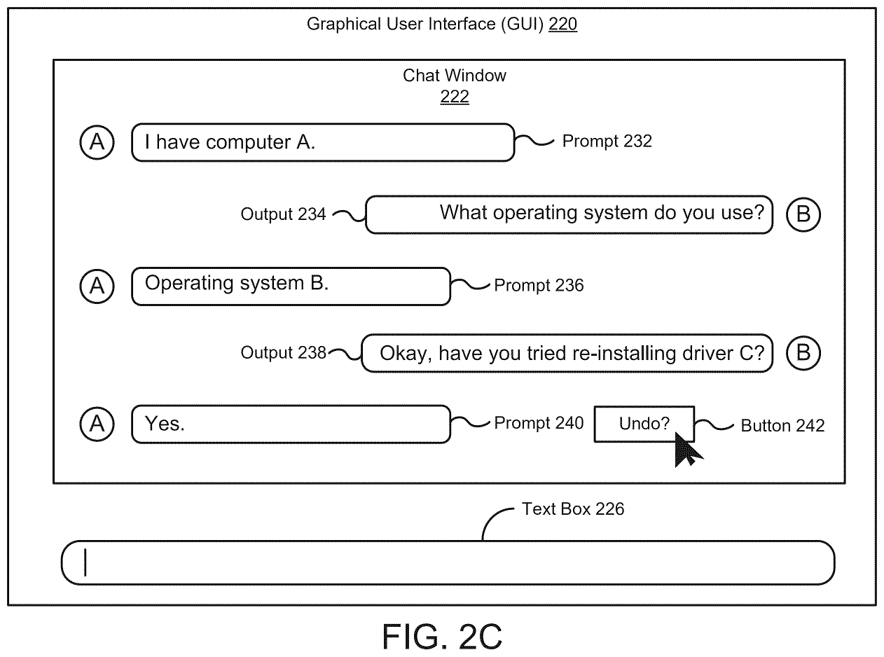

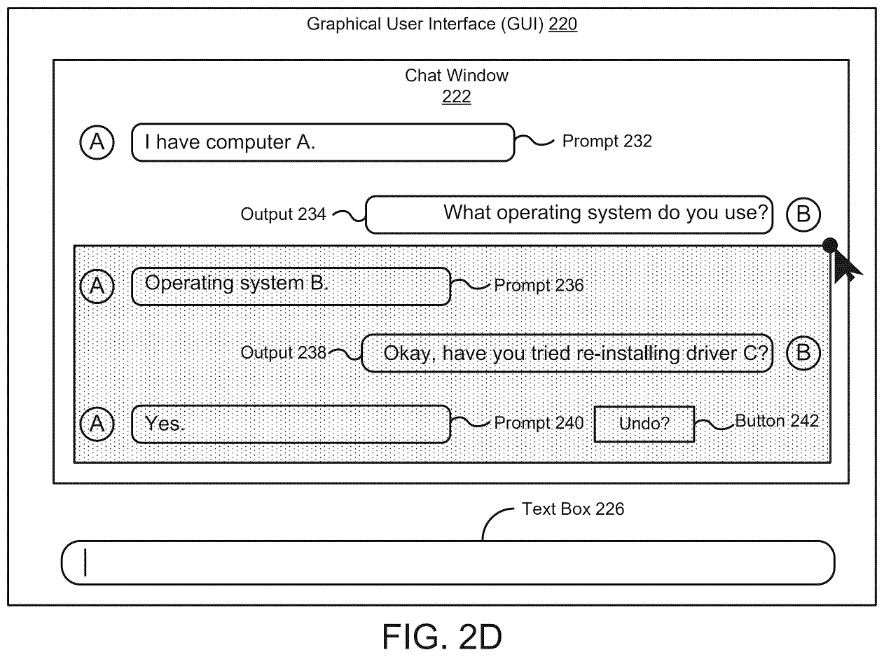

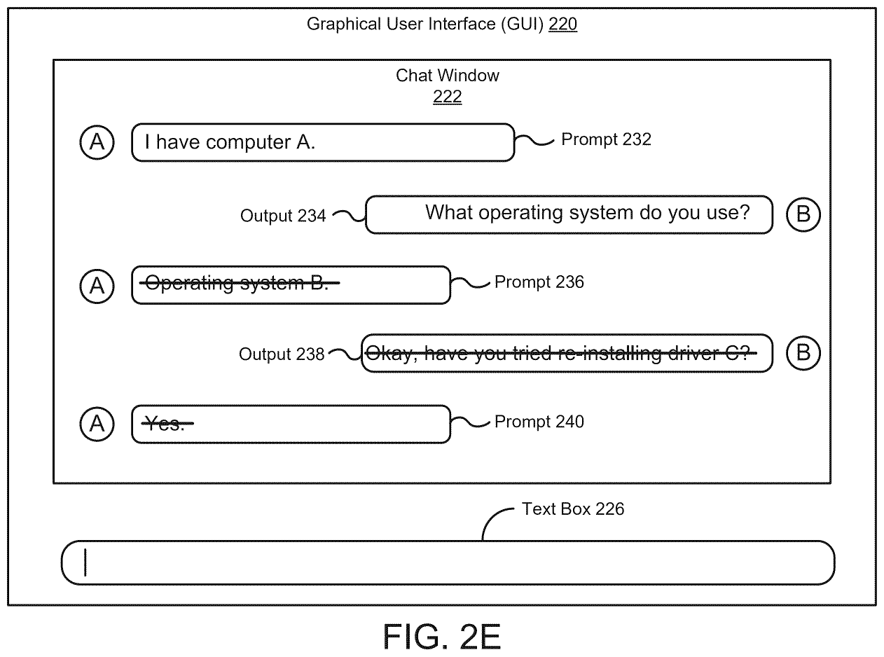

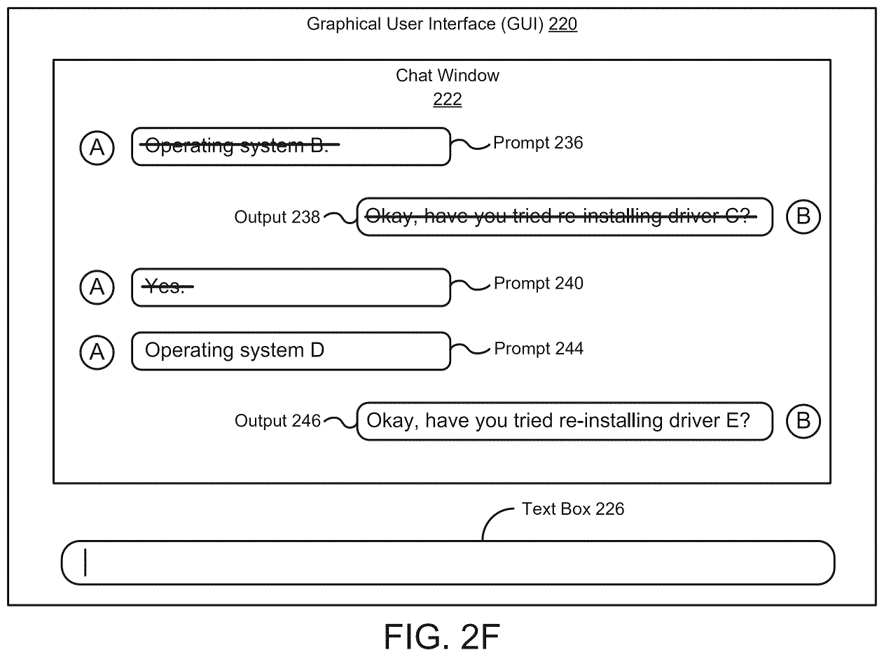

Selection of the undo button may allow the downstream consumer to provide additional input (e.g., the user may indicate an earlier point in time to which to revert the chat history). For example, the downstream consumer may choose to undo a most recent element of the chat history (e.g., a most recently provided prompt, a most recently provided output) or may choose (e.g., via highlighting on the chat window) to remove a larger portion of the chat history. Removing the larger portion of the chat history may include returning to an earlier point in the chat history while retaining at least a portion of the chat history (e.g., one or more prompts and outputs may remain). Refer to FIGS. 2B-2F for an example of returning to an earlier point in a chat history using interactive elements of the GUI.

The generative AI session history (e.g., the chat history) may include all prompts provided by the user during the chat session, all outputs provided to the user during the chat session, internal analysis information used by the generative AI model while generating outputs (e.g., information not provided to the user via the GUI), and/or other information related to the chat session. The generative AI model may be temporarily modified to obtain a temporarily updated generative AI model so that outputs generated by the temporarily updated generative AI model may be less influenced by the information content for the duration of the chat session.

Temporarily modifying the generative AI model may include: (i) adding a negating layer to the input layer of the generative AI model, (ii) adding a negating layer to a layer that feeds into an attention layer and/or a hidden layer of the attention layer, (iii) modifying (e.g., zero masking) embeddings corresponding to the information content that is requested to be removed, and/or (iv) other methods.

An output may, therefore, be generated by the temporarily updated generative AI model based on the generative AI session history. The output may be used to provide computer-implemented services to the user (e.g., the output may be added to the chat window).

At the conclusion of the chat session, the temporarily updated generative AI model may be reverted to the generative AI model (e.g., any temporary modifications to an internal state of the generative AI model may be reversed). Consequently, the request to remove the information content may not impact future chat sessions that the generative AI model participates in.

Thus, embodiments disclosed herein may provide an improved method for providing computer-implemented services using generative AI models. To provide the computer-implemented services as desired by downstream consumers, information content may be removable from a current chat session via selection of an interactive element (e.g., an undo button) thereby allowing the chat session to continue with a reduced impact of the removed information content. Doing so may increase a likelihood that outputs generated as part of the chat session are accurate and relevant to the needs of the downstream consumer. In addition, time resources for the downstream consumer may be conserved by reducing a need to begin new chat sessions when undesired information content is introduced.

In an embodiment, a method for providing computer-implemented services using generative AI models is provided. The method may include: making a first identification that a downstream consumer has requested, via at least selection by the downstream consumer of an interactive element on a graphical user interface (GUI), that a generative AI session history for a generative AI session is to be reverted to an earlier point in the generative AI session history while retaining at least a portion of the generative AI session history, the generative AI session history comprising prompts provided by the downstream consumer and outputs generated by a generative AI model of the generative AI models based on the prompts over a duration of time; based on the first identification: temporarily modifying the generative AI model to obtain a temporarily updated generative AI model so that outputs generated by the temporarily updated generative AI model are influenced less by a portion of the generative AI session history after the earlier point in the generative AI session history; obtaining, using the generative AI session history and the temporarily updated generative AI model, a first output of the outputs; and providing computer-implemented services using at least the first output.

The method may also include: prior to making the first identification: obtaining, from the downstream consumer and via the GUI, a prompt of the prompts; obtaining, using the prompt and the generative AI model, an output of the outputs; and populating the GUI using at least the prompt, the output, and the interactive element.

The interactive element may be an undo button.

Making the first identification may include: obtaining first user input indicating that the downstream consumer has selected the interactive element on the GUI; and obtaining second user input indicating information content that is desired to be removed from the generative AI session history.

The information content that is desired to be removed from the generative AI session history may include: at least one prompt of the prompts; and at least one output of the outputs, the at least one output corresponding to the at least one prompt.

The method may also include: after providing the computer-implemented services using at least the first output: making a second identification that the generative AI session has ended; and based on the second identification: reverting the temporarily updated generative AI model to the generative AI model.

The generative AI session history may include a record of the generative AI session. The generative AI session history may be displayed to the downstream consumer via the GUI.

Temporarily modifying the generative AI model may include: negating, based on the request, embeddings corresponding to information content that is desired to be removed from the generative AI session history to obtain the temporarily updated generative AI model.

Temporarily modifying the generative AI model may include: adding, based on the request, a negation layer to the generative AI model to obtain the temporarily updated generative AI model.

Temporarily modifying the generative AI model may include: adding, based on the request, a negation layer that feeds into an attention module of the generative AI model to obtain the temporarily updated generative AI model.

Temporarily modifying the generative AI model may include: adding, based on the request, a negation layer to a hidden layer of an attention module of the generative AI model to obtain the temporarily updated generative AI model.

The generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

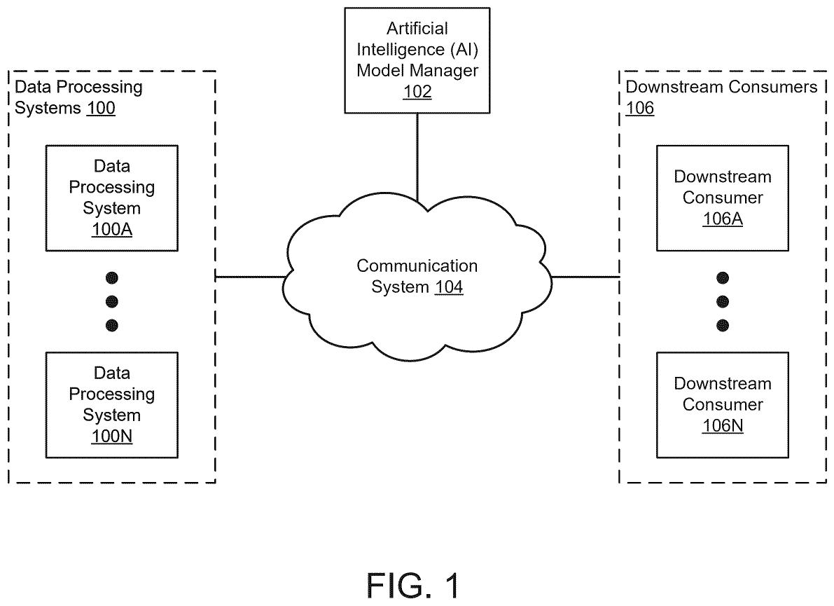

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via a graphical user interface (GUI) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with the downstream consumer during the chat session. The generative AI model may use all previous prompts and all previously generated outputs to generate each additional output as part of the chat session.

However, downstream consumer 106A may provide information content via a prompt that is: (i) erroneous, (ii) irrelevant, and/or (iii) otherwise not desired to be used during a remainder of the chat session. In addition, a prompt may elicit an unwanted response (e.g., a generative AI model output that does not meet expectations of downstream consumer 106A). As the information content may impact the remainder of the chat session, outputs generated by the generative AI model during the chat session may no longer meet expectations of downstream consumer 106A (e.g., may include inaccurate and/or irrelevant information). In addition, downstream consumer 106A may need to end the chat session and begin a new chat session with the AI agent to remove an impact of the undesired information content thereby incurring a cost of time resources for downstream consumer 106A that may be undesirable.

In general, embodiments disclosed herein may provide methods, systems, and/or devices for temporarily modifying a generative AI model instance for a duration of a chat session based on feedback from a downstream consumer. The downstream consumer may provide the feedback via selecting an interactive element of the GUI. The interactive element may be an undo button. The downstream consumer may utilize a human interface device (e.g., a mouse) to click on the undo button to initiate an action (e.g., the undo button may respond to user input). The undo button may include the text “undo?” and/or may be represented in any other way on the GUI without departing from embodiments disclosed herein.

The undo button may be positioned next to a most recent element of the chat history (e.g., a most recent prompt, a most recent output), may appear when the downstream consumer hovers over a portion of the chat history, and/or may appear via other methods.

For example, the downstream consumer may hover over a portion of the chat history and may select the undo button that appears next to the portion of the chat history. After clicking the undo button, the portion may be highlighted. The downstream consumer may then modify the highlighted portion (e.g., may scroll to a previous point in the chat history and extend the highlighting to the previous point in the chat history). By doing so, the downstream consumer may indicate that the chat history is to be reverted to an earlier point in the chat history. The downstream consumer may then confirm (e.g., via clicking another button, via pressing a key on a keyboard such as the “enter” key) that the highlighted portion is desired to be removed from the chat history.

The generative AI model may be temporarily modified based on the feedback from the downstream consumer. Temporarily modifying the generative AI model instance may include: (i) negating, based on the request, embeddings corresponding to the information content requested to be removed, (ii) adding, based on the request, a negation layer to the generative AI model instance, (iii) adding, based on the request, a negation layer that feeds into an attention module (e.g., attention layer) of the generative AI model instance, (iv) adding, based on the request, a negation layer to a hidden layer of an attention module of the generative AI model instance, (v) removing (e.g., deleting) tokens that correspond to the information content from a memory (e.g., attention) of the generative AI model, and/or (vi) other methods.

A temporarily updated generative AI model (e.g., a modified instance of the generative AI model) may be obtained and used to generate an output based on the generative AI session history. The output may be added to a record of the generative AI session displayed to the downstream consumer via the GUI.

At a conclusion of the chat session, the temporary modifications to the generative AI model instance may be reversed (e.g., a “memory wipe” may be performed for the generative AI model to remove temporarily added information such as zero masks) so that future chat sessions may not be impacted by the temporary modifications.

Thus, embodiments disclosed herein may improve processes of providing outputs generated by generative AI models to downstream consumers of the outputs. By allowing selection of portions of the chat history via an interactive element of the GUI, the downstream consumer may return a generative AI session to an earlier point in the generative AI session history. By doing so, an impact of portions of the generative AI session history after the point in the generative AI session history may be lessened when new outputs are generated by the generative AI model during the generative AI session. Consequently, a likelihood of providing desired computer-implemented services while conserving time resources may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

As part of providing the computer-implemented services, data processing systems 100 may: (i) obtain prompts for generative AI models (e.g., hosted and/or operated by data processing systems 100), (ii) feed the prompts into a generative AI model to obtain outputs, and (iii) provide the outputs to downstream consumers as part of providing computer-implemented services to the downstream consumers.

Data processing systems 100 may provide chat session services to downstream consumers 106. For example, one or more of downstream consumers 106 may host AI agents that manage chat sessions with users (e.g., downstream consumers). A record of the chat sessions may be displayed, via the GUI, on a user's device (e.g., one or more of downstream consumers 106).

As part of providing the computer-implemented services, data processing systems 100 may also: (i) identify that a downstream consumer has requested, via at least selection of an interactive element on a GUI, that a generative AI session history for a generative AI session be reverted to an earlier point in the generative AI session history while retaining at least a portion of the generative AI session history, (ii) temporarily modifying the generative AI model to obtain a temporarily updated generative AI model so that outputs generated by the temporarily updated generative AI model are less influenced by a portion of the generative AI session history after the earlier point in the generative AI session history, (iii) obtain, from the temporarily updated generative AI model and based on the generative AI session history, a first output, (iv) provide computer-implemented services to the downstream consumer using at least the first output, and/or (v) perform other actions.

At the conclusion of the chat session, data processing systems 100 may revert the temporarily updated generative AI model to the generative AI model (e.g., internal modifications such as zero masks may be removed) so that future chat sessions may not be impacted by the modifications to the generative AI model.

Refer to FIG. 2A for additional details regarding temporarily modifying the generative AI model. Refer to FIGS. 2B-2F for an example of a chat session during which information content of a portion of the generative AI session history is removed.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

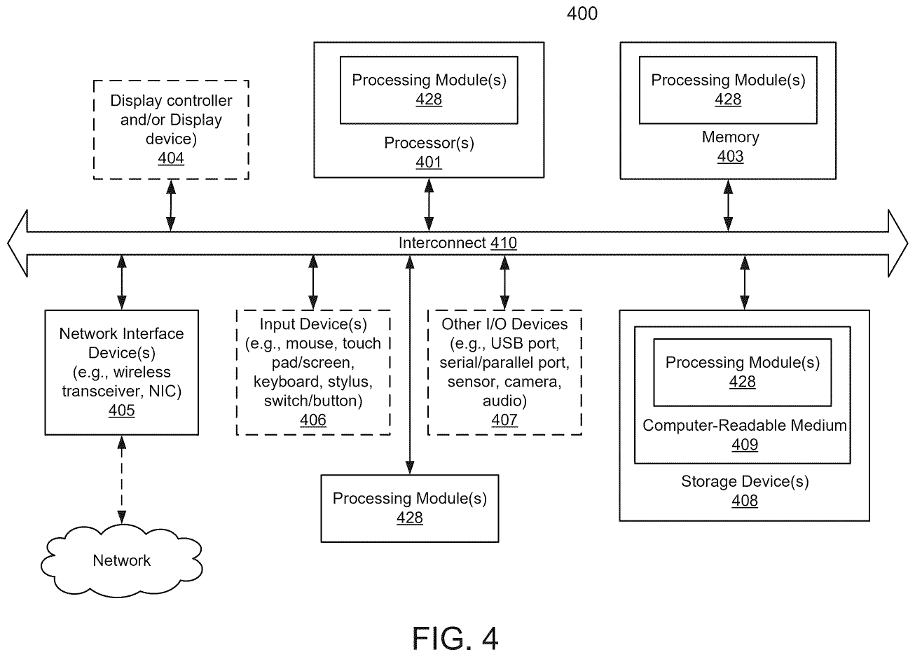

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

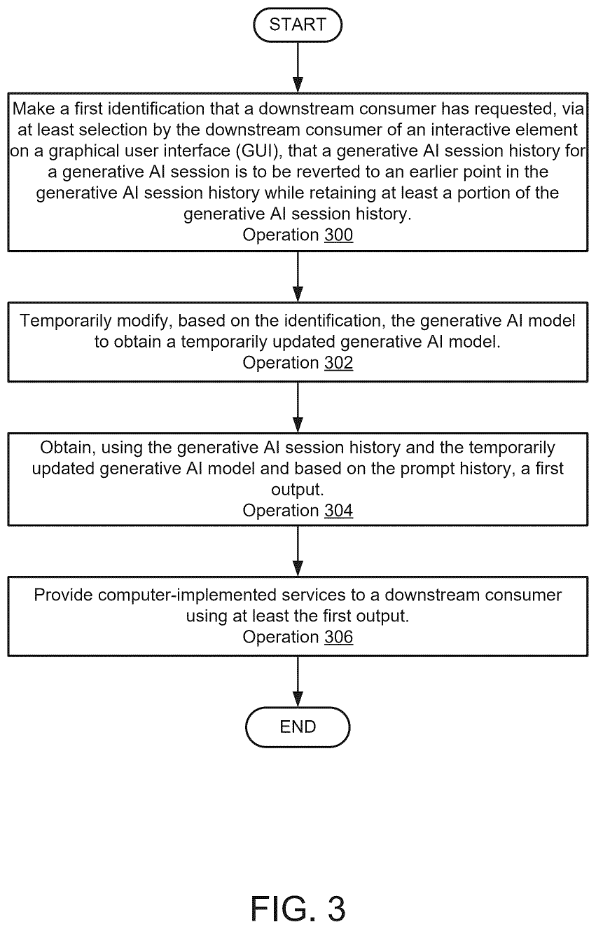

While providing their functionality, any of data processing systems 100, AI model manager 102, and/or downstream consumers 106 may provide all or a portion of the methods shown in FIGS. 2A-3.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 206, etc.) is used to represent data structures, a second set of shapes (e.g., 204, 212 etc.) is used to represent processes performed using and/or that generate data, and a third set of shapes (e.g., 202, 210) is used to represent generative AI models, and/or other types of models.

Turning to FIG. 2A, a data flow diagram in accordance with an embodiment is shown. The data flow diagram may illustrate data used in and data processing performed in providing computer-implemented services using at least an output generated by a temporarily updated generative AI model.

As part of providing the computer-implemented services, a downstream consumer (e.g., 106A) may initiate a chat session (e.g., with an AI agent hosted by one or more of data processing systems 100). During the chat session, the downstream consumer may provide prompts and the AI agent may provide responses (e.g., outputs generated by a generative AI model based on the prompts). A record of the chat session may be included in chat history 206. During the chat session, the downstream consumer may select information content to be removed from the generative AI session history (e.g., including prompts provided during the chat session).

Request 200 may be obtained from the downstream consumer and may include an indication of the information content that is requested to be removed from chat history 206. Chat history 206 may include any number of prompts (e.g., prompt A-prompt N) and any number of outputs based on the prompts (e.g., output A-output N). Prompt A, for example, may have been provided by the downstream consumer during the chat session and may have been used to generate output A (e.g., by the generative AI model). Output A may be generated by feeding prompt A into generative AI model 202. An AI agent (e.g., a software program) may retrieve output A and may populate a chat window on the GUI using output A as part of the chat session.

Request 200 may be provided, by the downstream consumer, via an interaction with a graphical user interface (GUI) (not shown, refer to FIGS. 2B-2F for an example GUI). The GUI may display, to the downstream consumer, a record of the chat session that includes chat history 206. The GUI may also include any number of interactive elements (e.g., buttons).

An interactive element of the interactive elements may include an undo button. The undo button may be any type of button included in a GUI (e.g., a call to action button, a primary button), may or may not include text (e.g., “undo?”), and may appear on the GUI via various methods.

For example, the undo button may appear: (i) automatically next to portions of the chat history (e.g., next to each prompt and each output, next to a most recent output or prompt), (ii) when the downstream consumer uses a mouse to select a portion of the chat history (e.g., by hovering a cursor over the portion, by clicking on the portion), and/or (iii) as part of other processes (e.g., the downstream consumer may enter a command or select another interactive element to enter into a chat history modification mode). Refer to FIGS. 2B-2F for an example GUI and an example generative AI session.

Therefore, request 200 may include first user input indicating that the downstream consumer has clicked on the interactive element (e.g., the undo button). Request 200 may also include second user input indicating information content (e.g., one or more prompts, one or more outputs) that is desired to be removed from chat history 206.

For example, clicking on the undo button may allow the downstream consumer to select an earlier point in chat history 206 (e.g., the downstream consumer may scroll back in chat history 206 and select an earlier point, the downstream consumer may scroll back and highlight a portion of chat history 206 after the earlier point). By selecting the earlier point in chat history 206, request 200 may indicate that the downstream consumer desires to revert chat history 206 to the earlier point (e.g., to remove information content related to all of the prompts, outputs, and/or other information after the earlier point in chat history 206). By doing so, an impact of the removed information content may be reduced for future outputs generated during the chat session.

Generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein.

To remove the portion of chat history 206, temporary AI model modification process 204 may be performed. During temporary AI model modification process 204, modifications may be made to an internal state of generative AI model 202 to obtain temporarily updated generative AI model 210 (e.g., a modified instance of generative AI model 202).

Making modifications to the internal state of generative AI model 202 may include: (i) negating, based on request 200, embeddings corresponding to the portion of chat history 206 that is desired to be removed to obtain temporarily updated generative AI model 210 (e.g., identifying the embeddings and zero masking the embeddings so they are ignored when ingested), (ii) removing (e.g., deleting) tokens that correspond to the portion of chat history 206 from a memory (e.g., attention) of generative AI model 202, (iii) adding, based on request 200, a negation layer to generative AI model 202 to obtain temporarily updated generative AI model 210, (iv) adding, based on request 200, a negation layer that feeds into an attention module of generative AI model 202 to obtain temporarily updated generative AI model 210, and/or (v) adding, based on request 200, a negation layer to a hidden layer of an attention module of generative AI model 202 to obtain temporarily updated generative AI model 210.

The negation layers may be placed so that information content corresponding to the portion of chat history 206 that is desired to be removed (e.g., sequences of tokens similar to and/or the same as tokens of the portion of chat history 206 that is desired to be removed) pass through the negation layers at different points in the architecture of temporarily updated generative AI model 210 (e.g., prior to or after the input layer, prior to the attention module, in a hidden layer of the attention module). Therefore, when the same and/or similar tokens pass through the negation layers, operations may be performed to modify the values of the tokens.

Temporarily updated generative AI model 210 may, therefore, include one or more of the above modifications thereby reducing an impact of the information content on future outputs generated by temporarily updated generative AI model 210.

Temporarily updated generative AI model 210 and chat history 206 may be used to perform output generation process 212 to obtain output 214. During output generation process 212, chat history 206 may be fed into temporarily updated generative AI model 210 to generate output 214 as output. However, temporarily updated generative AI model 210 may include one or more negations (e.g., negation layers, masked embeddings) so that information content of at least output A is removed from an internal state of temporarily updated generative AI model 210 and so that output A may have a reduced impact on output 214.

At the conclusion of the chat session, temporarily updated generative AI model 210 may be reverted to generative AI model 202 so that future chat sessions are not impacted by request 200. For example, any negation layers of temporarily updated generative AI model 210 may only impact tokens of the input that was desired to be removed from the generative AI session history and, consequently, the negation layers may not impact new input data (e.g., temporarily updated generative AI model 210 may not require active reversion to generative AI model 202). If any zero masking or manual deletion of portions of memory of generative AI model 202 was performed, a memory wipe may be performed to remove the zero masks and/or other memory modifications thereby reverting attention values and available contextual information of generative AI model 202 to an internal state prior to the temporary update.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by implementing the data flows shown in FIG. 2A, a system in accordance with embodiments disclosed herein may be used to obtain requests (e.g., feedback) for removal of information content from a generative AI session history of a chat session via selection (e.g., by the downstream consumer) of an interactive element of the GUI. By modifying a generative AI model based on the feedback, the chat session may continue with a reduced impact of the information content. Consequently, a reliability and/or usefulness of outputs may be increased for the downstream consumer.

Turning to FIG. 2B, an example graphical user interface (GUI) is shown. GUI 220 may display at least chat window 222 and text box 226. GUI 220 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Other entities (e.g., an AI agent managing a chat service, a data processing system hosting the AI agent and/or any number of generative AI models) may populate GUI 220 with data intended to be displayed to the downstream consumer.

A downstream consumer may initiate a chat session with an AI agent (e.g., a computer program such as a chatbot) and chat window 222 and text box 226 may be displayed on GUI 220 to the downstream consumer for a duration of the chat session.

A customer may open chat window 222 and may enter prompt 223 into text box 226. Prompt 223 may include the following text: “My computer is not working. I need help.” Prompt 223 is shown next to a circle with the letter “A” inside the circle to indicate input from a first entity (e.g., the downstream consumer).

Prompt 223 may be used as ingest for a generative AI model and output 224 may be obtained as output from the generative AI model. The generative AI model (e.g., and/or an AI agent participating in the chat session) may provide output 224 as a response to prompt 223. Output 224 may include the following text: “Sure, I can help you with that! What seems to be the problem with your computer?” Output 224 is shown next to a circle with the letter “B” inside the circle to indicate input from a second entity (e.g., the generative AI model by way of the AI agent).

The downstream consumer may provide prompt 228 in response to output 224 and to continue the generative AI session (e.g., the chat session). Prompt 228 may include the text: “My computer is overheating.” The generative AI model may take into account (e.g., may use as input) at least prompt 223, output 224, and prompt 228 to generate output 230. Therefore, each output generated by the generative AI model may be generated in the context of the entire interaction.

Output 230 may include the text: “What kind of computer do you have?” The generative AI model may be configured to prompt the downstream consumer to provide specific types of information based on the prompts provided by the downstream consumer.

The downstream consumer may provide prompt 232 in response. Prompt 232 may include the text: “I have computer A.”

The generative AI model may utilize the entire chat history to generate output 234 with the text: “What operating system do you use?” In response to output 234, the downstream consumer may provide prompt 236 with the text: “Operating system B.”

The generative AI model may utilize the entire chat history to generate output 238 with the text: “Okay, have you tried re-installing driver C?” The downstream consumer may provide prompt 240 in response to output 238, prompt 240 including the text: “Yes.”

Turning to FIG. 2C, a zoomed-in portion of the generative AI session shown in FIG. 2B is shown. While only prompt 232, output 234, prompt 236, output 238, and prompt 240 are shown in FIG. 2C, it may be appreciated that the generative AI session shown in FIG. 2C is the same generative AI session shown in FIG. 2B. The zoomed-in portion of the generative AI session is shown in FIG. 2C for clarity.

The downstream consumer may decide that the generative AI session is to be reverted to an earlier point in the generative AI session history. For example, the downstream consumer may realize that they accidentally provided inaccurate information in prompt 236 (e.g., they may not use operating system B). The downstream consumer may wish to revert the generative AI session to an earlier point in the generative AI session history for other reasons without departing from embodiments disclosed herein.

To revert the generative AI session to an earlier point in the generative AI session history, the downstream consumer may select an interactive element of GUI 220. The interactive element may be button 242 and button 242 may include the text “Undo?” Button 242 may include other text, may have other shapes, may be positioned in other locations on GUI 220, and/or may otherwise be any other kind of button without departing from embodiments disclosed herein.

In FIG. 2C, button 242 may appear next to a most recent element (e.g., prompt or output) in chat window 222. For example, the downstream consumer may hover the cursor over prompt 240 and button 242 may appear. Button 242 may appear permanently next to the most recent element, may appear following other interactions (e.g., entering a command into text box 226, selecting other interactive elements on GUI 220) without departing from embodiments disclosed herein.

Turning to FIG. 2D, the downstream consumer may provide first user input by clicking on button 242. Clicking on button 242 may initiate a highlighting process by which the downstream consumer may provide second user input (e.g., may indicate an earlier point in the chat history to which the chat session history is to be reverted.

In FIG. 2D, the earlier point in the chat session history may be prior to prompt 236 (e.g., prompt 236, output 238, and prompt 240 may be highlighted). The downstream consumer may modify the earlier point in the chat session by selecting the filled in circle in the top right-hand corner of the highlighted section and dragging the circle up or down to modify an extent of the selection. The earlier point in the chat history may be selected via other interactions with GUI 220 without departing from embodiments disclosed herein.

Turning to FIG. 2E, prompt 236, output 238, and prompt 240 may be crossed out to indicate that information content related to prompt 236, output 238, and prompt 240 have been removed from the generative AI session history. By doing so, the generative AI session may be reverted to the earlier point in time (e.g., with output 234 being a most recent element of the generative AI session history). At least a portion of the generative AI session history may be retained. For example, prompt 232 and output 234 may be retained. Output 230, prompt 228, output 224, and prompt 223 may also be retained but may not be shown in FIG. 2D for clarity. Removal of information content may be indicated in other ways (e.g., prompt 236, output 238, and prompt 240 may disappear from chat window 222) without departing from embodiments disclosed herein.

Turning to FIG. 2F, the generative AI session elements shown in chat window 222 may be an extension of the same generative AI session shown in FIGS. 2B-2E. The downstream consumer may have reverted the generative AI session history back to remove prompt 236, output 238, and prompt 240 to offer a different response to output 234 (not shown) than what was previously provided in prompt 236. For example, downstream consumer may enter the text “operating system D” into text box 226. Prompt 244 may be added to chat window 222 based on the entered text.

In response to prompt 244 and using the entire generative AI session history with a reduced impact from prompt 236, output 238, and prompt 240, the generative AI model may generate output 246 with the text: “Okay, have you tried re-installing driver E?”

By utilizing the “undo” functionality provided by button 242, the downstream consumer may revert the generative AI session history to an earlier point while retaining a portion of the generative AI session history to avoid beginning a new generative AI session.

Thus, FIGS. 2B-2F show an example GUI and an example of a chat session between a downstream consumer and a backend system (e.g., an entity that hosts and/or operates generative AI models). It may be appreciated that the GUI may include other elements and information may be provided by the downstream consumer to the backend system via other methods without departing from embodiments disclosed herein.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, a first identification may be made that a downstream consumer has requested, via at least selection by the downstream consumer of an interactive element on a graphical user interface (GUI), that a generative AI session history for a generative AI model is to be reverted to an earlier point in the generative AI session history while retaining at least a portion of the generative AI session history. The generative AI session history may include prompts provided by the downstream consumer and outputs generated by the generative AI model based on the prompts over a duration of time.

Making the first identification may include: (i) obtaining first user input indicating that the downstream consumer has selected the interactive element on the GUI, (ii) obtaining second user input indicating information content that is desired to be removed from the generative AI session history, and/or (iii) other methods.

Obtaining the first user input may include: (i) receiving feedback, via the GUI, indicating that the downstream consumer has clicked on an interactive element of the GUI (e.g., an undo button), (ii) reading the first user input from storage, (iii) receiving the first user input from another entity, and/or (iv) other methods.

Obtaining the second user input may include methods similar to those described with respect to obtaining the first user input. For example, obtaining the second user input may include receiving feedback, via the GUI, that the downstream consumer has: (i) highlighted a portion of the generative AI session history, (ii) typed in a command and/or other text to indicate the earlier point in time of the generative AI session history, and/or (iii) otherwise selected the information content desired to be removed.

Prior to making the first identification, a prompt of the prompts may be obtained from the downstream consumer and via the GUI. Obtaining the prompt may include: (i) receiving a notification that the downstream consumer has typed in the prompt to a text box (e.g., an interactive element that allows the downstream consumer to type and enter text using a human interface device such as a keyboard) of the GUI, (ii) reading the prompt from storage, (iii) receiving the prompt from another entity, and/or (iv) other methods.

An output of the outputs may also be obtained prior to making the first identification using the prompt and the generative AI model. Obtaining the output may include: (i) feeding at least the prompt into the generative AI model as ingest and obtaining, as an output from an output layer of the generative AI model, the output, (ii) reading the output from storage, (iii) receiving the output from another entity, and/or (iv) other methods.

The GUI may be populated using at least the prompt, the output, and the interactive element prior to making the first identification. Populating the GUI may include: (i) uploading the prompt and the output to the GUI using an application programming interface (API), a software program, and/or other means of displaying data to the downstream consumer via the GUI (e.g., via a chat interface of the GUI), (ii) providing the output and the prompt to another entity responsible for uploading the prompt and the output to the GUI, (iii) generating a portion of code that defines properties of the interactive element (e.g., visual aspects such as size, shape and color, text included in the interactive element, actions linked to activation of the interactive element), (iv) adding the portion of code to a codebase for the GUI, (v) providing the portion of code to another entity, (vi) providing the properties of the interactive element and instructions for generating the portion of the code to another entity, and/or (vii) other methods.

At operation 302, the generative AI model may be temporarily modified, based on the request, to obtain a temporarily updated generative AI model. Temporarily modifying the generative AI model may include: (i) negating, based on the request, embeddings corresponding to information content that is desired to be removed from the generative AI session history to obtain the temporarily updated generative AI model, (ii) adding, based on the request, a negation layer to the generative AI model to obtain the temporarily updated generative AI model, (iii) adding, based on the request, a negation layer that feeds into an attention module of the generative AI model to obtain the temporarily updated generative AI model, (iv) adding, based on the request, a negation layer to a hidden layer of an attention module of the generative AI model to obtain the temporarily updated generative AI model, (v) removing (e.g., deleting) tokens that correspond to the information content from a memory (e.g., attention) of the generative AI model, and/or (vi) other methods.

Negating the embeddings may include: (i) obtaining the embeddings corresponding to the information content (e.g., reading the embeddings from storage, obtaining the embeddings from another entity), (ii) zero masking the embeddings from (e.g., so that they are ignored when processed), and/or (iii) other methods.

Adding the negation layer to the generative AI model may include: (i) identifying elements (e.g., neurons) of an input layer of the generative AI model that consume the information content, (ii) performing an operation to modify a latent representation of the information content prior to or following ingestion by the neurons of the input layer, and/or (iii) other methods. Modifying the latent representation may include changing attention values of the input (e.g., multiplying the attention values by negative one). By doing so, the information content may be processed in a negated form (e.g., by the input layer, by a layer of neurons after the input layer).

Adding the negation layer (e.g., a layer that performs the modification of the information content) that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module.

Adding the negation layer to the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

At operation 304, an output may be obtained from the temporarily updated generative AI model and based on the prompt history. Obtaining the output may include: (i) feeding the chat history (e.g., the generative AI session history) into the generative AI model to obtain the output from an output layer of the generative AI model, (ii) providing the chat history to another entity responsible for operating the generative AI model, and/or (iii) other methods.

At operation 306, computer-implemented services may be provided to a downstream consumer using at least the output. Providing the computer-implemented services to the downstream consumer may include: (i) populating the GUI with at least the output (e.g., as part of a chat session), (ii) making decisions based on at least the output, (iii) providing the output to another entity, (iv) selecting one or more actions based on the output and performing the one or more actions to update operation of a system, and/or (v) other methods.

The method may end following operation 306.

After providing the computer-implemented services, a second identification may be made that the generative AI session has ended. Making the second identification that the generative AI session has ended may include obtaining feedback from a downstream consumer via the GUI (e.g., the downstream consumer may exit a chat window, the downstream consumer may close a website, the downstream consumer may enter a command initiating an end to the chat session.

After the chat session has ended, the temporarily updated generative AI model may be reverted to the generative AI model. Reverting the temporarily updated generative AI model to the generative AI model may include: (i) reversing a masking of embeddings corresponding to the information content, (ii) performing a memory wipe for the generative AI model (e.g., reversing modifications to attention values, tokens, and/or other internal representations of the generative AI model), (iii) and/or other methods.

Thus, as illustrated above, embodiments disclosed herein may provide systems and methods usable to provide computer-implemented services using generative AI models. By temporarily modifying a generative AI model to remove an impact of information content from a chat session, a likelihood of future outputs generated during the chat session meeting needs of the downstream consumer may be increased.

Any of the components illustrated in FIGS. 1-2F may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
making a first identification that a downstream consumer has requested, via at least selection by the downstream consumer of an interactive element on a graphical user interface (GUI), that a generative AI session history for a generative AI session is to be reverted to an earlier point in the generative AI session history while retaining at least a portion of the generative AI session history, the generative AI session history comprising prompts provided by the downstream consumer and outputs generated by a generative AI model of the generative AI models based on the prompts over a duration of time;
based on the first identification:
temporarily modifying the generative AI model to obtain a temporarily updated generative AI model so that outputs generated by the temporarily updated generative AI model are influenced less by a portion of the generative AI session history after the earlier point in the generative AI session history;
obtaining, using the generative AI session history and the temporarily updated generative AI model, a first output of the outputs; and
providing computer-implemented services using at least the first output.

2. The method of claim 1, further comprising:
prior to making the first identification:
obtaining, from the downstream consumer and via the GUI, a prompt of the prompts;
obtaining, using the prompt and the generative AI model, an output of the outputs; and
populating the GUI using at least the prompt, the output, and the interactive element.

3. The method of claim 1, wherein the interactive element is an undo button.

4. The method of claim 1, wherein making the first identification comprises:
obtaining first user input indicating that the downstream consumer has selected the interactive element on the GUI; and
obtaining second user input indicating information content that is desired to be removed from the generative AI session history.

5. The method of claim 4, wherein the information content that is desired to be removed from the generative AI session history comprises:
at least one prompt of the prompts; and
at least one output of the outputs, the at least one output corresponding to the at least one prompt.

6. The method of claim 1, further comprising:
after providing the computer-implemented services using at least the first output:
making a second identification that the generative AI session has ended; and
based on the second identification:
reverting the temporarily updated generative AI model to the generative AI model.

7. The method of claim 1, wherein the generative AI session history comprises a record of the generative AI session and the generative AI session history is displayed to the downstream consumer via the GUI.

8. The method of claim 1, wherein temporarily modifying the generative AI model comprises:
negating, based on the request, embeddings corresponding to information content that is desired to be removed from the generative AI session history to obtain the temporarily updated generative AI model.

9. The method of claim 1, wherein temporarily modifying the generative AI model comprises:
adding, based on the request, a negation layer to the generative AI model to obtain the temporarily updated generative AI model.

10. The method of claim 1, wherein temporarily modifying the generative AI model comprises:
adding, based on the request, a negation layer that feeds into an attention module of the generative AI model to obtain the temporarily updated generative AI model.

11. The method of claim 1, wherein temporarily modifying the generative AI model comprises:
adding, based on the request, a negation layer to a hidden layer of an attention module of the generative AI model to obtain the temporarily updated generative AI model.

12. The method of claim 1, wherein the generative AI model is a large language model (LLM).

13. A non-transitory machine-readable medium having instructions stored therein, which when executed by a processor, cause the processor to perform operations for providing computer-implemented services using generative artificial intelligence (AI) models, the operations comprising:
making a first identification that a downstream consumer has requested, via at least selection by the downstream consumer of an interactive element on a graphical user interface (GUI), that a generative AI session history for a generative AI session is to be reverted to an earlier point in the generative AI session history while retaining at least a portion of the generative AI session history, the generative AI session history comprising prompts provided by the downstream consumer and outputs generated by a generative AI model of the generative AI models based on the prompts over a duration of time;
based on the first identification:
temporarily modifying the generative AI model to obtain a temporarily updated generative AI model so that outputs generated by the temporarily updated generative AI model are influenced less by a portion of the generative AI session history after the earlier point in the generative AI session history;
obtaining, using the generative AI session history and the temporarily updated generative AI model, a first output of the outputs; and
providing computer-implemented services using at least the first output.

14. The non-transitory machine-readable medium of claim 13, wherein the operations further comprise:
prior to making the first identification:
obtaining, from the downstream consumer and via the GUI, a prompt of the prompts;
obtaining, using the prompt and the generative AI model, an output of the outputs; and
populating the GUI using at least the prompt, the output, and the interactive element.

15. The non-transitory machine-readable medium of claim 13, wherein the interactive element is an undo button.

16. The non-transitory machine-readable medium of claim 13, wherein making the first identification comprises:
obtaining first user input indicating that the downstream consumer has selected the interactive element on the GUI; and
obtaining second user input indicating information content that is desired to be removed from the generative AI session history.

17. A data processing system, comprising:
a processor; and
a memory coupled to the processor to store instructions, which when executed by the processor, cause the processor to perform operations for providing computer-implemented services using generative artificial intelligence (AI) models, the operations comprising:
making a first identification that a downstream consumer has requested, via at least selection by the downstream consumer of an interactive element on a graphical user interface (GUI), that a generative AI session history for a generative AI session is to be reverted to an earlier point in the generative AI session history while retaining at least a portion of the generative AI session history, the generative AI session history comprising prompts provided by the downstream consumer and outputs generated by a generative AI model of the generative AI models based on the prompts over a duration of time;
based on the first identification:
temporarily modifying the generative AI model to obtain a temporarily updated generative AI model so that outputs generated by the temporarily updated generative AI model are influenced less by a portion of the generative AI session history after the earlier point in the generative AI session history;
obtaining, using the generative AI session history and the temporarily updated generative AI model, a first output of the outputs; and
providing computer-implemented services using at least the first output.

18. The data processing system of claim 17, wherein the operations further comprise:
prior to making the first identification:
obtaining, from the downstream consumer and via the GUI, a prompt of the prompts;
obtaining, using the prompt and the generative AI model, an output of the outputs; and
populating the GUI using at least the prompt, the output, and the interactive element.

19. The data processing system of claim 17, wherein the interactive element is an undo button.

20. The data processing system of claim 17, wherein making the first identification comprises:
obtaining first user input indicating that the downstream consumer has selected the interactive element on the GUI; and
obtaining second user input indicating information content that is desired to be removed from the generative AI session history.
